(19) United States
(12) Patent Application Publication
(10) Pub. No.: US 2024/0318887 A1
(43) Pub. Date: Sep. 26, 2024

(54) ICE DAM HAMMER

(71) Applicant: Heath David McClaflin, Chester, MA (US)

(72) Inventor: Heath David McClaflin, Chester, MA (US)

(21) Appl. No.: 18/732,831

(22) Filed: Jun. 4, 2024

Related U.S. Application Data
(63) Continuation-in-part of application No. 17/334,949, filed on May 31, 2021, now abandoned.

(51) Int. Cl. F25C 5/04; B25G 3/28; E04D 13/10

(52) U.S. Cl. CPC F25C 5/043; B25G 3/28; E04D 13/106

(57) ABSTRACT

An article of manufacture for providing an ice dam hammer is made from an ice breaking head, coupled to a tubular aluminum adapter designed to connect to the detachable handle of an existing article of manufacture known as a roof rake. The ice breaking head includes a main breaking head whereas the lower/bottom side of the ice breaking head has a plurality of blunt protrusions. The upper/top side of the ice braking head has two flat protrusions. The one side of the hammer head is pointed. The second side of the hammer head has a rounded end.

### RELATED APPLICATIONS AND INCORPORATION BY REFERENCE

This application claims priority to, and is a continuation in part of, U.S. patent application Ser. No. 17/334,949, entitled ICE DAM HAMMER, filed on May 31, 2021, the entire disclosure of which is incorporated herein by reference.

### TECHNICAL FIELD OF THE INVENTION

This application relates in general to an article of manufacture for providing a snow and ice removal aid and more specifically to an article of manufacture providing an ice dam hammer.

### BACKGROUND OF THE INVENTION

Packed snow and ice dams form on roofs following a snowfall. The snow can melt and refreeze especially about the eaves of the building which may lead to water damage and breaks in the roofing and building material. Removal of these ice dams can be dangerous if a worker is required to use a ladder to get close to the ice and packed snow to break it into pieces so that it may be removed from the roof Depending upon the height of the building having the ice dams, the user may have difficulty safely reaching the roof at a required depth while remaining a safe distance from the edge of the roof.

Therefore, a need exists for an article of manufacture for providing an ice dam hammer for the safe removal of ice dams on eves of roofs. The present invention attempts to address the limitations and deficiencies in prior solutions according to the principles and example embodiments disclosed herein.

### SUMMARY OF THE INVENTION

In accordance with the present invention, the above and other problems are solved by providing an article of manufacture for an ice dam hammer according to the principles and example embodiments disclosed herein.

In one embodiment, the present invention is an article of manufacture for providing an ice dam hammer. The ice dam hammer is made from an ice breaking head coupled to a tubular aluminum adapter made to connect to the detachable handle of a pre-existing article of manufacture known as a roof rake. The ice breaking head includes a main breaking head having a point on the left/first side, a rounded protrusion on the right/second side, five rounded protrusions on the bottom/lower side and two flat protrusions on the top/upper side of the breaking head, a blind hole in the rear/back side of the breaking head to accept a tubular aluminum adapter, and a blind hole centered in the upper/top side of the ice braking head which accepts a stainless steel set screw through a screw clearance hole in the adapter in order to secure the breaking head to the adapter.

In another aspect of the present invention, the adapter is made of hollow aluminum tube with a screw clearance hole on the first end to accept the insertion ball of a retention clip located within the hollow aluminum tube of a roof rake handle and a screw clearance hole on the second end to accept the stainless-steel set screw to secure the main braking head to the adapter.

In another aspect of the present invention, the insertion ball of the retention clip located in the hollow roof rake handle engages the screw clearance connection hole in the first end of the adapter to hold the adapter in place.

In another aspect of the present invention the stainless-steel set screw passes through the second screw clearance hole in the adapter and engages the ice dam hammer head to secure the hammer head to the adapter.

In another aspect of the present invention, the ice breaking head is made of anodized aluminum and weighs 4 lbs.

The foregoing has outlined rather broadly the features and technical advantages of the present invention, in order that the detailed description of the invention that follows may be better understood. Additional features and advantages of the invention will be described here and after that form the subject of the claims of the invention.

It should be appreciated by those skilled in the art that the conception and specific embodiment disclosed may be readily utilized as a basis for modifying or designing other structures for carrying out the same purpose of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantage, will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which, like reference numbers, represent corresponding parts throughout

FIG. 1 Illustrates an example embodiment of an article of manufacture providing an ice dam hammer according to the present invention

FIG. 2 Illustrates a front side/face view of an article of manufacture providing an ice dam hammer breaking head according to the present invention

FIG. 3 Illustrates a rear side/back view of the ice breaking head of an article of manufacture for providing an ice dam hammer according to the present invention.

FIG. 4 Illustrates a side view of connection between the adapter of the ice dam hammer, a roof rake handle and the ice breaking head of the ice dam hammer according to the present invention.

FIG. 5 Illustrates a view of the retention clip that connects the roof rake handle to the adapter of the ice dam hammer according to the present invention

FIG. 6 Illustrates the stainless-steel set screw that connects the breaking head of an ice dam hammer to the adapter of the ice dam hammer according to the present invention.

### DETAILED DESCRIPTION OF THE PREFERRED EMBODIMENTS

This application relates in general to an article of manufacture for providing a specialized ice and packed snow removal aid, and more specifically to an article of manufacture for providing an ice dam hammer according to the present invention.

Various embodiments of the present invention will be described in detail with reference to the drawings, wherein like reference, numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a”, “an” and “the” include plural reference, unless the context clearly dictates otherwise. As used herein, a plurality of items, structural elements, compositional elements, and or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a” “an” and “the” are intended to include the plural forms as well, unless the context clearly dictates otherwise.

It further, it will be understood that the terms “comprises”, “comprising”, “includes” and “including” specify the presence of stated features, steps, or components, but do not preclude the presence or addition of one or more other features, steps, or components. It should also be noted that in some alternative implementations, the functions and acts noted may occur out of the order noted in the figures. For example, two figures shown in succession may in fact, be executed substantially concurrently or may sometimes be executed. In the reverse order, depending upon the functionality and acts involved.

The terms “worker” and “user” refer to an entity, EG a human, using an adjustable ice dam hammer associated with the invention. The term user herein refers to one or more users.

The term invention or present invention refers to the invention being applied for via the patent application. The title Ice dam hammer or invention may be used interchangeably with hammer.

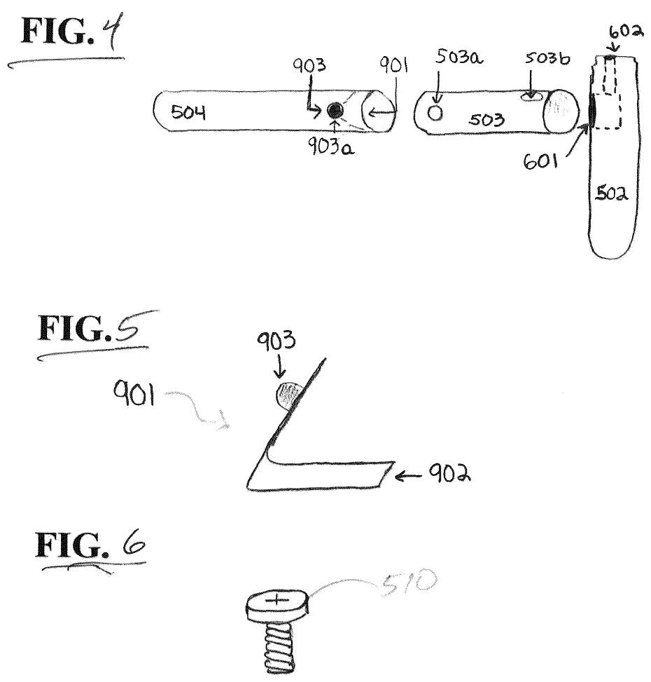

In general, the present disclosure relates to an article of manufacture for providing an ice dam hammer. To better understand the present invention, FIG. 5 Illustrates an example embodiment of an article of manufacture providing an ice dam hammer 501 according to one embodiment of the present invention. As will be appreciated, the Ice Dam Hammer 501 may be used by a worker, user, or homeowner to safely break up ice dams that form about the edges of a building's roof while standing on the ground outside of the building.

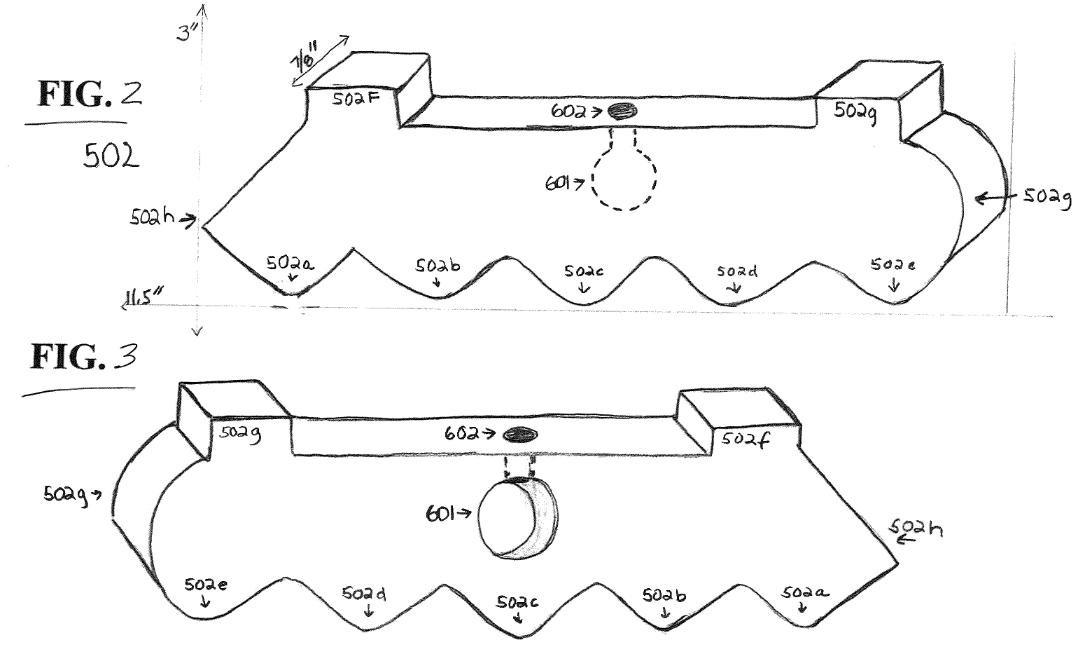

In operation, a user standing on the ground can raise the ice dam hammer 501 on an opposing end of a detachable handle 504 of a pre-existing article of manufacture, commonly referred to as a roof rake, above a lower edge of a roof by extending the ice dam hammer 501 above and over the edge of the roof. The user can swing the hammer head 502 downward to cause the lower side protrusions 502a-e of the ice breaking head 502 to crash downward onto ice and packed snow on the roof By repeated strikes from the ice dam hammer 501, the lower side protrusions 502a-e of the breaking head 502 will cause the ice and impacted snow to be broken into pieces (see, FIGS. 2 and 3).

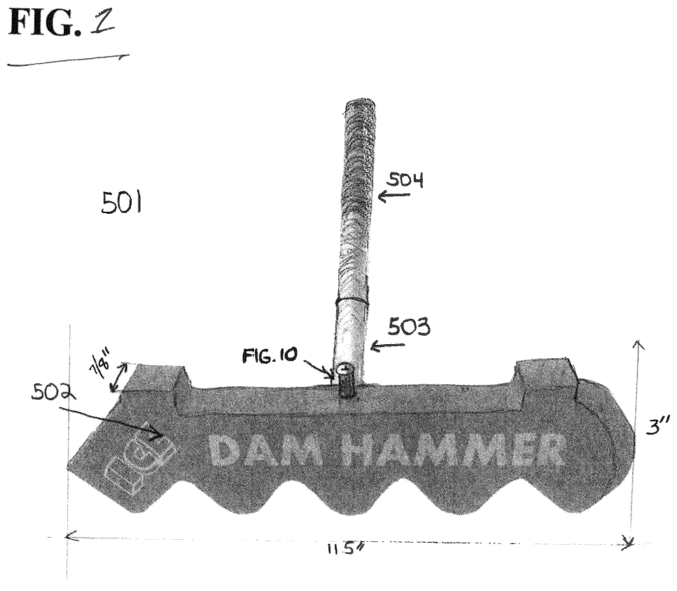

As shown in FIG. 1, the Ice Dam Hammer 501 compromises an anodized aluminum head 502 coupled to a tubular aluminum adapter 503 designed to connect to a detachable handle 504 of a pre-existing article of manufacture commonly referred to as a roof rake. The tubular aluminum adapter may connect to and detach from the handle of a roof rake 504 using an attachment mechanism 903, best shown in FIG. 5.

As best illustrated in FIGS. 1, 3 and 4, the ice breaking head 502 is coupled to the aluminum adapter 503 by inserting the adapter 503 into the blind receiving hole 601 in the hammer head 502, and coupled thereto by action of a stainless steel set screw 510 inserted through the screw clearance receiving hole 602 in the hammer head 502. In order to readily break through ice and packed snow the ice breaking head 502 preferably has a weight of at least 4 lbs. Additional details of the icebreaking head 502 are described below in reference to FIG. 2 and FIG. 3.

As discussed, FIG. 1 illustrates a front view of an article of manufacture providing an ice dam hammer 501 according to one embodiment of the present invention. The Ice Dam Hammer 501 is shown with the ice breaking head 502 attached to an existing roof rake handle 504 with the utilization of the aluminum adapter 503. The ice breaking head 502 extends downward from the aluminum adapter 503.

FIG. 2 illustrates a front view of an ice breaking head 502 of an article of manufacture for providing an ice dam hammer 501 according to the present invention. The hammer head 502 is shown having a generally rectangular/oblong shape and is preferably made of anodized aluminum weighing preferably at least 4 lbs. The ice breaking head 502 preferably has a length of 11.5 inches along each side of the rectangle, a depth of 3 inches and a thickness of ⅞^{th} inch in the preferred embodiment of FIG. 1. The ice breaking head 502 has 5 blunted protrusions 502a-e on the lower/bottom side of the ice breaking head 501. The upper/top side of the ice braking head 502 has two flat protrusions 502f-g. The one/left side of the hammer head 502h is pointed. The second/right side of the hammer head 502i has a rounded end.

FIG. 4 illustrates a side view of the connections between an existing roof rake handle 504, the tubular aluminum adapter 503 is 1 inch in diameter with a wall thickness of 0.049 inches and is 6 inches in length, and the hammer head 502 of an ice dam hammer 501 according to the present invention and is shown to include a retention clip 901 shown in FIG. 5 that engages a connection hole 903a in the existing roof rake handle 504. The retention clip 901 compromises a bent clip 902 having an insertion ball 903 on an outside edge of the bent clip 902. The insertion ball 903 is sized to securely fit into the connection hole 903a when the hole 903a and insertion ball 903 are aligned. The insertion ball 903 passes through the connection hole 903a when the aluminum adapter 503 accepts the existing roof rake handle 504. With the insertion ball 903 in place within the connection hole 903a, the aluminum adapter 503 is prevented from rotating or moving laterally with respect to the existing roof rake handle 504.

The retention clip 901 is located within the inner existing roof rake handle 504 with each side of the bent clip 902 in contact with the inner sides of the hollow tube. The bent clip 902 generates an outward force to push the attached insertion ball 903 outward and hold the insertion ball 903 in place in the insertion hole 903a. A user may press downward on the insertion ball 903 to push the insertion ball out of the connection hole 903a in order to allow the adapter 503 to be disconnected from the roof rake handle 504.

FIG. 3 Illustrates a rear/back view of a preferred embodiment of an ice breaking head 502 of an article of manufacture for providing an ice dam hammer 501 according to the present invention. The aluminum adapter 503 is inserted into the blind receiving hole 601 in the hammerhead 502 and is coupled with a stainless-steel set screw 510 (see, FIG. 9) inserted through the blind receiving hole 602 in the hammerhead 502.

Even though particular combinations of features are recited in the present application. These combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

It will be readily appreciated that while the ice breaking head 502 has been described as having five lower side protrusions 502a-e, the present invention is not so limited in this regard, as there be more of less of the lower side protrusions without departing from the broader aspects of the present invention.

Moreover, while a tubular aluminum adapter 503 has been disclosed, it will be readily appreciated by one of ordinary skill that the operational/functional features of the tubular aluminum adapter 503 may instead be formed on the roof rake handle 504, itself, without departing from the broader aspects of the present invention.

As best seen in FIGS. 1-3, it will be appreciated that the structure of the ice breaking head 502 provides four distinct sides with which to attack snow and ice build-up on a surface, such as a roof. Indeed, by having not only separate sides of the ice breaking head 502, but by forming ice breaking protrusions on each of these four sides, and by defining differing structural configurations to each of these ice breaking protrusions, the present invention provides an ice hammer that has a wide variety of uses and applications.

In particular, depending on the ice and snow conditions currently faced, a user may choose to utilize either the lower side protrusions 502a-e, or the two flat protrusions 502f-g, formed on the opposing side edge of the ice breaking head 502. Similarly, it may be alternatively advantageous for a user to instead utilize the pointed and angled protrusion 502h, or the rounded end 502g, if greater, more concentrated point-force is desired.

Thus, the present invention provides at least four functional sides to the ice breaking head 502, each of which defines ice and snow breaking structures of differing configurations. In this manner, a user may switch between different ice and snow breaking techniques without having to change tools or requiring a complex attachment of extraneous devices.

It will also be appreciated by one of ordinary skill in the art that the ice dam head 502 of the present invention acts as both a snow rake, given its generally rectangular/oblong shape and length, as well as an ice hammer, owing to various and differing ice breaking protrusions formed on the ice breaking head 502.

Adapter 503 permits the ice breaking head 502 to be utilized with a wide variety of traditional garden handle assemblies. Moreover, as will be appreciated, the blunt protrusions on the lower side of the head allow the user to apply repeated blows to the ice dams and packed snow on the roof eve without causing damage to the roofing material. The pointed and round ends may be alternatively used to apply a targeted blow in a restricted area of the roof line, or when the depth of the ice/snow is greater than the depth of the ice breaking head 502 (i.e., when the ice/snow is deeper than 3″).

No element, act, or instruction used in the present application should be construed as critical or essential to the invention unless explicitly described as such. Further, the phrase based on is intended to mean based, at least in part, on unless explicitly stated otherwise.

What is claimed is:

1. A tool assembly for the removal of ice and snow from a surface, said tool assembly comprising:
a handle portion;
a head portion releasably connected to said handle portion, said head portion having two sets of opposing profiles defining thereby four separate contact surfaces;
wherein a first of said contact surfaces defines a plurality of undulating protuberances;
wherein a second of said contact surfaces defines a pair of flattened protuberances;
wherein a third of said contact surfaces defines a pointed protuberance; and
wherein a fourth of said contact surfaces defines a rounded protuberance.

2. A tool assembly for the removal of ice and snow from a surface according to claim 1, further comprising:
an adapter for permitting said handle to be releasably connected to said head portion;
wherein said handle comprises a retention clip having an insertion ball on one end of a bent clip located within a hollow interior of said handle; and
wherein said insertion ball passes through and engages a connection hole in said adapter to hold said handle in place.

3. A tool assembly for the removal of ice and snow from a surface according to claim 1, wherein:
said head portion is made of aluminum, weighing at least 4 lbs.

4. A tool assembly for the removal of ice and snow from a surface according to claim 2, wherein:
said head portion is coupled to one of said handle and said adapter via a set-screw assembly.

5. A method of forming a tool assembly for the removal of ice and snow from a surface, said method comprising the steps of:
providing a handle portion;
providing a head portion releasably connected to said handle portion, said head portion having two sets of opposing profiles defining thereby four separate contact surfaces;
defining a plurality of undulating protuberances on a first of said contact surfaces;
defining a pair of flattened protuberances on a second of said contact surfaces;
defining a pointed protuberance on a third of said contact surfaces; and
defining a rounded protuberance on a fourth of said contact surfaces.

6. The method of forming a tool assembly for the removal of ice and snow from a surface according to claim 1, said method further comprising the steps of:
providing an adapter for permitting said handle to be releasably connected to said head portion, wherein said handle comprises a retention clip having an insertion ball on one end of a bent clip located within a hollow interior of said handle; and
utilizing said insertion ball to pass through and engages a connection hole in said adapter to hold said handle in place.

7. The method of forming a tool assembly for the removal of ice and snow from a surface according to claim 1, said method further comprising the steps of:
forming said head portion from aluminum, weighing at least 4 lbs.

8. The method of forming a tool assembly for the removal of ice and snow from a surface according to claim 6, said method further comprising the steps of:
releasably coupling said head portion to one of said handle and said adapter via a set-screw assembly.

9. A tool assembly for the removal of ice and snow, said tool assembly comprising:
a handle portion;
a head portion releasably connected to said handle portion, said head portion having a first set of opposing profiles and a second set of opposing profiles;
wherein first set of opposing profiles includes a first surface having a plurality of undulating protuberances extending outwardly therefrom;
wherein first set of opposing profiles includes a second surface having a pair of flattened protuberances extending outwardly therefrom; and
wherein said first set of opposing profiles are defined on opposing longitudinal sides of said head portion, while said second set of opposing profiles are defined on defined on opposing lateral sides of said head portion, said opposing longitudinal sides being longer than said opposing lateral sides.

10. A tool assembly for the removal of ice and snow according to claim 9, wherein:
said second set of opposing profiles include a third surface having a pointed protuberance extending outwardly therefrom; and
said second set of opposing profiles include a fourth surface having a rounded protuberance extending outwardly therefrom.

11. A tool assembly for the removal of ice and snow according to claim 9, further comprising:
an adapter for permitting said handle to be releasably connected to said head portion;
wherein said handle comprises a retention clip having an insertion ball on one end of a bent clip located within a hollow interior of said handle; and
wherein said insertion ball passes through and engages a connection hole in said adapter to hold said handle in place.

12. A tool assembly for the removal of ice and snow from a surface according to claim 9, wherein:
said head portion is made of aluminum, weighing at least 4 lbs.

13. A tool assembly for the removal of ice and snow from a surface according to claim 11, wherein:
said head portion is coupled to one of said handle and said adapter via a set-screw assembly.
